(19) United States
(12) Patent Application Publication
(10) Pub. No.: US 2026/0072187 A1
(43) Pub. Date: Mar. 12, 2026

(54) RADIATION IMAGE CAPTURING DEVICE AND RADIATION IMAGE CAPTURING SYSTEM

(71) Applicant: CANON KABUSHIKI KAISHA, Tokyo (JP)

(72) Inventors: JUN KAWANABE, Saitama (JP); RYOSUKE MIURA, Chiba (JP)

(21) Appl. No.: 19/308,537

(22) Filed: Aug. 25, 2025

(30) Foreign Application Priority Data
Sep. 11, 2024 (JP) 2024-157732

(51) Int. Cl. G01T 1/24

(52) U.S. Cl. CPC G01T 1/247

(57) ABSTRACT

A radiation image capturing device including an image capturing region in which pixels are arranged, signal lines, a signal processor, and a driver is provided. The pixels include image capturing pixels and detection pixels for acquiring irradiation information. The image capturing region includes receptor fields each constituted by a predetermined number of pixels which are continuous in a row direction and a column direction. Each receptor field includes detection regions each including one or more detection pixel, the detection regions being connected to different signal lines for each of detection regions in each receptor field. The signal processor acquires the irradiation information based on signals supplied from detection pixels arranged in each of the detection regions by causing the driver to drive detection pixels which are arranged in a receptor field set for acquisition of the irradiation information.

### BACKGROUND

### Field of the Technology

The present disclosure relates to a radiation image capturing device and a radiation image capturing system.

### Description of the Related Art

A radiation image capturing device is made multifunctional so as to, for example, perform automatic exposure control (AEC) upon detecting an incident radiation dose by detecting the irradiation information of radiation entering the radiation image capturing device. Japanese Patent Laid-Open No. 2014-052191 discloses that signal lines to which detection pixels for acquiring an accumulated dose output signals are divided for each large block corresponding to a receptor field at the time of performing AEC.

### SUMMARY

In the arrangement disclosed in Japanese Patent Laid-Open No. 2014-052191, when one large block includes both a region where an object is present and a region where no object is present, signals cannot be separately acquired from detection pixels arranged in the respective regions. This can lead to a situation where the AEC accuracy deteriorates, for example, the irradiation with radiation is stopped by AEC based on the signals output from the detection pixels located in the region where no object is present in spite of the object being irradiated with an insufficient radiation dose.

Some embodiments of the present disclosure provide a technique advantageous in improving the AEC accuracy.

According to some embodiments, a radiation image capturing device comprising: an image capturing region in which a plurality of pixels are arranged in a matrix pattern; a plurality of signal lines to which signals are respectively supplied from pixels, of the plurality pixels, which are arranged on a same pixel column; a signal processing circuit; and a drive circuit, wherein the plurality of pixels include a plurality of image capturing pixels for acquiring a radiation image and a plurality of detection pixels for acquiring irradiation information of radiation separately from the radiation image, the image capturing region includes a plurality of receptor fields each constituted by a predetermined number of pixels, of the plurality of pixels, which are continuous in a row direction and a column direction, each receptor field includes a plurality of detection regions each including not less than one detection pixel of the plurality of detection pixels, the plurality of detection regions being connected to different signal lines of the plurality of signal lines for each of the plurality of detection regions in each receptor field, and the signal processing circuit acquires the irradiation information based on signals supplied from detection pixels arranged in each of the plurality of detection regions by causing the drive circuit to drive detection pixels, of the plurality of detection pixels, which are arranged in a receptor field set for acquisition of the irradiation information during irradiation with radiation, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing an example of the arrangement of a radiation image capturing system including a radiation image capturing device according to the present embodiment;

FIG. 2 is a circuit diagram showing an example of the arrangement of the radiation image capturing device according to the present embodiment;

FIG. 3 is a plan view showing an example of the arrangement of pixels of the radiation image capturing device in FIG. 2;

FIGS. 4A and 4B are sectional views showing an example of the arrangements of pixels of the radiation image capturing device in FIG. 2;

FIG. 5 is a view showing an example of the placement of receptor fields in the radiation image capturing device in FIG. 2;

FIG. 6 is a timing chart showing a driving example of the radiation image capturing device in FIG. 5;

FIGS. 7A and 7B are views showing an example of the placement of the receptor fields in the radiation image capturing device in FIG. 2;

FIG. 8 is a timing chart showing a driving example of the radiation image capturing device in FIGS. 7A and 7B;

FIG. 9 is a timing chart showing a driving example of the radiation image capturing device in FIGS. 7A and 7B; and

FIG. 10 is a view showing a modification of the radiation image capturing device in FIGS. 7A and 7B.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Note that radiation according to the present disclosure can include not only α-rays, β-rays, and γ-rays that are beams generated by particles (including photons) emitted by radioactive decay but also beams having energy equal to or higher than the energy of these beams, for example, X-rays, particle rays, and cosmic rays.

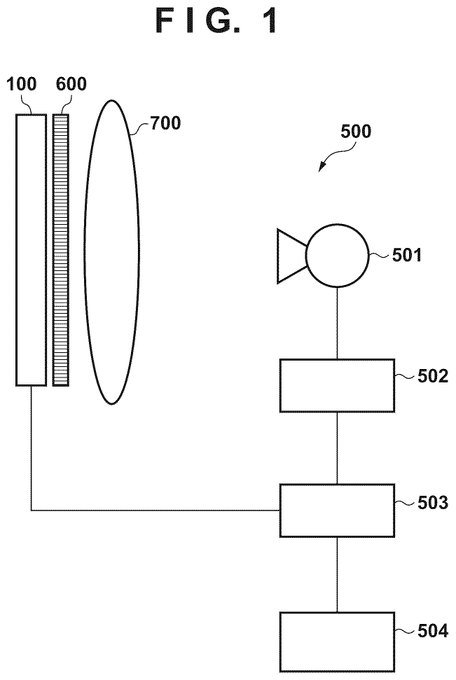

The radiation image capturing device according to an embodiment of the present disclosure will be described with reference to FIGS. 1 to 10. FIG. 1 shows an example of the arrangement of a radiation image capturing system 500 including a radiation image capturing device 100 according to the present embodiment. The radiation image capturing system 500 includes the radiation image capturing device 100, a radiation source 501, a radiation source interface 502, a communication interface 503, a controller 504, and a grid 600 and captures a radiation image of an object 700. FIG. 1 shows an example in which the radiation image capturing device 100 communicates with the radiation source 501 by wire. However, limitation is not made thereto, and the radiation image capturing device 100 and the radiation source 501 may be configured to communicate with each other wirelessly. The grid 600 is provided to remove scattered radiation and may not be used depending on the object 700.

A dose, an irradiation time (ms), a tube current (mA), a tube voltage (kV), a receptor field as a region for detecting radiation, and the like are input to the controller 504. When an exposure switch attached to the radiation source 501 is operated, the controller 504 transmits a start request signal to the radiation image capturing device 100. The start request signal is a signal for requesting the start of irradiation with radiation. In response to the reception of the start request signal, the radiation image capturing device 100 starts preparation for the reception of irradiation with radiation. Upon completion of preparation for capturing a radiation image, the radiation image capturing device 100 transmits a start enable signal to the radiation source interface 502 via the communication interface 503. The start enable signal is a signal for notifying that irradiation with radiation can be started. The radiation source interface 502 causes the radiation source 501 to start irradiation with radiation in response to the reception of the start enable signal.

When the integrated dose of radiation applied has reached a target threshold or is expected to reach the target threshold, the radiation image capturing device 100 transmits an end request signal to the radiation source interface 502 via the communication interface 503. The end request signal is a signal for requesting the end of the irradiation with radiation. In response to the reception of the end request signal, the radiation source interface 502 causes the radiation source 501 to end the irradiation with radiation at a proper timing. A target dose threshold is determined based on an input value of dose, a radiation irradiation intensity, a communication delay between units, a processing delay, and the like.

The controller 504 may perform processing in the radiation source interface 502 which is performed in accordance with the start enable signal or the end request signal output from the radiation image capturing device 100. In addition, for example, the controller 504 may process data for a radiation image output from the radiation image capturing device after capturing of a radiation image and display the radiation image on a display (not shown) or the like. The radiation source interface 502 and the controller 504 can be regarded as functioning as a signal processing unit that processes the signal output from the radiation image capturing device 100.

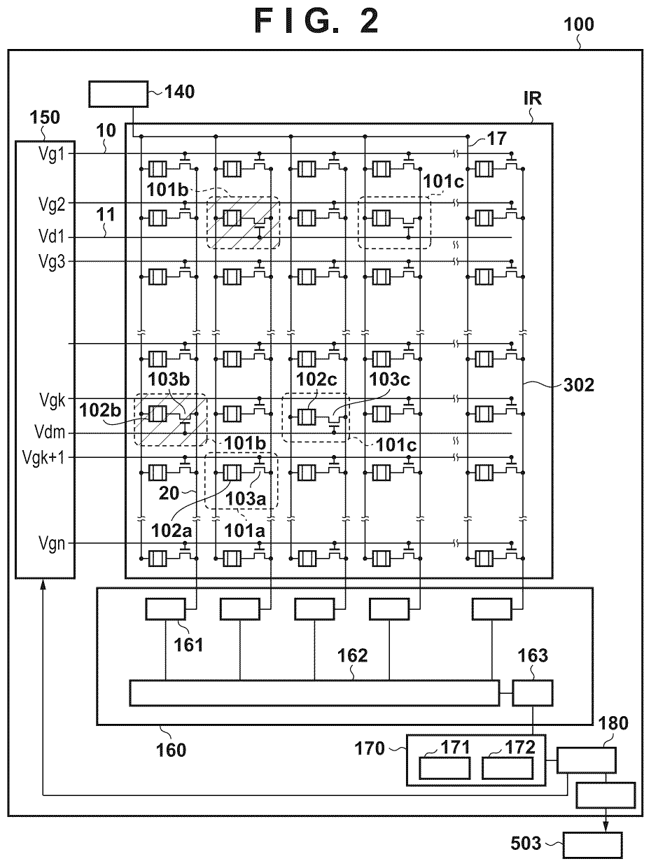

FIG. 2 shows an example of the arrangement of the radiation image capturing device 100 according to the present disclosure. The radiation image capturing device 100 includes an image capturing region IR in which a plurality of pixels are arranged in a matrix pattern, a plurality of drive lines 10 and 11, a plurality of signal lines 302 to which signals are respectively supplied from pixels, of the plurality of pixels, which are arranged on the same pixel column, a signal processing circuit 170, and a drive circuit 150. The plurality of drive lines 10 and 11 are respectively provided in correspondence with pixel rows constituted by pixels 101 arranged in the image capturing region IR. The plurality of signal lines 302 are respectively provided in correspondence with pixel columns constituted by the pixels 101 arranged in the image capturing region IR.

The plurality of pixels 101 include a plurality of pixels 101a for acquiring a radiation image and a plurality of pixels 101c for acquiring the irradiation information of radiation independently of a radiation image. In addition, the plurality of pixels 101 may include a plurality of pixels 101b used to correct the radiation irradiation dose. For the sake of understanding the present disclosure, the pixel 101a of the plurality of pixels 101 is sometimes referred to as the “image capturing pixel” 101a. Likewise, the pixel 101c is sometimes referred to as the “detection pixel” 101c, and the pixel 101b is sometimes referred as a the “correction pixel” 101b. In addition, a pixel manifesting no specific use will be simply referred to as the pixel 101. As shown in FIG. 2, the plurality of detection pixels 101c and the plurality of correction pixels 101b may include the detection pixel 101c and the correction pixel 101b connected to the same drive line of the plurality of drive lines 10 and 11.

The image capturing pixel 101a can include a conversion element 102a that converts radiation into an electrical signal and a switch element 103a for outputting the electrical signal generated by the conversion element 102a to the corresponding signal line 302. The correction pixel 101b can include a conversion element 102b that converts radiation into an electrical signal and a switch element 103b for outputting the electrical signal generated by the conversion element 102b to the corresponding signal line 302. The detection pixel 101c can include a conversion element 102c that converts radiation into an electrical signal and a switch element 103c for outputting the electrical signal generated by the conversion element 102c to the corresponding signal line 302. The correction pixel 101b and the detection pixel 101c are arranged so as to be included in a row and a column constituted by the plurality of image capturing pixels 101a. In the following description, a conversion element and a switch element of a pixel manifesting no specific use will be sometimes simply referred to as a conversion element 102 and a switch element 103.

The conversion element 102 may be constituted by a scintillator that converts radiation into light and a photoelectric conversion element that converts light into an electrical signal. The scintillator is generally formed in the form of a sheet covering the image capturing region IR and can be shared by the plurality of pixels 101. Instead of the scintillator, the conversion element 102 may be formed of a conversion element that directly converts radiation into an electrical signal.

The switch element 103 may include, for example, a thin-film transistor (TFT) whose active region is formed from a semiconductor such as amorphous silicon or polycrystalline silicon. One electrode of the conversion element 102 is connected to one main electrode of the switch element 103. The other electrode of the conversion element 102 is connected to a bias line 17. The bias line 17 extends in the column direction between the pixels 101 and is commonly connected to the other electrode of each of the plurality of conversion elements 102 arrayed in the column direction. The bias line 17 supplies a bias potential Vs from a power supply circuit 140 to the conversion element 102. The other main electrode of the switch element 103 of the pixel 101 included in one pixel column is connected to one corresponding signal line 302. The control electrode of the switch element 103a provided for the image capturing pixel 101a included in one pixel row of the plurality of pixels 101 is connected to the corresponding one drive line 10. The control electrodes of the switch elements 103b and 103c provided for the correction pixel 101b and the detection pixel 101c included in one pixel row of the plurality of pixels 101 are connected to the corresponding one drive line 11. In this manner, the plurality of image capturing pixels 101a and the plurality of detection pixels 101c may be connected to different drive lines of the plurality of drive lines 10 and 11. In addition, the plurality of image capturing pixels 101a and the plurality of correction pixels 101b may be connected to different drive lines of the plurality of drive lines 10 and 11.

The drive circuit 150 is configured to drive the pixel 101 to be driven by supplying a drive signal to the drive target pixel 101 via the plurality of drive lines 10 and 11 in accordance with the control signal supplied from a control circuit 180. The drive line 10 to which the image capturing pixel 101a is connected and the drive line 11 to which the detection pixel 101c and the correction pixel 101b are connected may be respectively connected to different drive circuits. More specifically, the drive line 10 may be connected to a drive circuit for image capturing, and the drive line 11 may be connected to a drive circuit for detecting the irradiation information of radiation. In the present embodiment, a drive signal is a signal for turning on the switch element 103 included in the drive target pixel 101. For example, the switch element 103 of each pixel 101 can be turned on by a high-level signal and turned off by a low-level signal. Accordingly, in the present embodiment, this high-level signal is called a drive signal. However, limitation is not made thereto, and the switch element 103 may be turned on by a low-level signal and turned off by a high-level signal. Supplying a drive signal to the pixel 101 will enable a readout circuit 160 to read out a signal (electricity) converted from radiation by the conversion element 102 of the pixel 101 and accumulated.

The readout circuit 160 is configured to read out the signals output from the plurality of pixels 101 to the corresponding signal lines 302. The readout circuit 160 can include a plurality of amplification circuits 161 respectively corresponding to the plurality of signal lines 302, a multiplexer 162, and an analog/digital (AD) converter 163. The plurality of signal lines 302 are respectively connected to the corresponding amplification circuits 161 of the plurality of amplification circuits 161 provided in the readout circuit 160. The one signal line 302 corresponds to the one amplification circuit 161. The multiplexer 162 selects the plurality of amplification circuits 161 in a predetermined order and supplies a signal from the selected amplification circuit 161 to the AD converter 163. The AD converter 163 converts a supplied signal into a digital signal and outputs it.

The signal read out from the image capturing pixel 101a is supplied to the signal processing circuit 170 to cause the signal processing circuit 170 to execute processing such as an arithmetic operation and a storing operation. More specifically, the signal processing circuit 170 may include an arithmetic circuit 171 and a storage circuit 172. The arithmetic circuit 171 generates image data for a radiation image based on the signals read out from the image capturing pixels 101a and supplies the data to the control circuit 180. Since no image capturing pixel 101a is present at the coordinates at which the detection pixel 101c and the correction pixel 101b are located, a deficit can occur on a radiation image. For this reason, when generating image data for a radiation image, the signal processing circuit 170 may complement a deficit by using the signals read out from the image capturing pixel 101a near the deficit. The signals read out from the correction pixel 101b and the detection pixel 101c are supplied to the signal processing circuit 170 and subjected to processing such as an arithmetic operation and a storing operation by the arithmetic circuit 171. More specifically, the signal processing circuit 170 outputs irradiation information indicating the irradiation of the radiation image capturing device 100 with radiation based on the signal read out from the detection pixel 101c. For example, the signal processing circuit 170 may detect the start or end of the irradiation of the image capturing region IR with radiation or determine a radiation irradiation dose or an integrated irradiation dose.

The control circuit 180 controls the overall radiation image capturing device 100. The control circuit 180 may control the drive circuit 150 and the readout circuit 160 based on irradiation information supplied from the signal processing circuit 170. In addition, the control circuit 180 may control, for example, the start and end of exposure (the accumulation of electric charge corresponding to applied radiation by the image capturing pixel 101a) based on the irradiation information supplied from the signal processing circuit 170.

In order to determine a radiation irradiation dose, the control circuit 180 scans only the drive line 11 during irradiation with radiation by controlling the drive circuit 150, thereby making ready to read out signals from the correction pixel 101b and the detection pixel 101c. The control circuit 180 then controls the readout circuit 160 to read out the signals supplied to the signal lines 302 provided for pixel columns corresponding to the correction pixels 101b and the detection pixels 101c, thereby acquiring irradiation information indicating a radiation irradiation dose. With this operation, the radiation image capturing device 100 can obtain irradiation information in the detection pixel 101c during irradiation with radiation. One or more each of the correction pixel 101b, the detection pixel 101c, and the drive line 11 are provided in a receptor field as a region for detecting radiation. In addition, one or more such receptor fields are arranged in the image capturing region IR. The correction pixel 101b and the detection pixel 101c are driven via the drive line 11 provided in a receptor field set for the acquisition of irradiation information to read out signals from the correction pixel 101b and the detection pixel 101c, thereby acquiring irradiation information corresponding to the dose of radiation incident on the selected receptor field. The user can set a receptor field for the acquisition of irradiation information by operating the controller 504. For example, the user may select a receptor field to be used, or the control circuit 180 may select an appropriate receptor field in accordance with information such as a region to be image-captured and an mAs value setting.

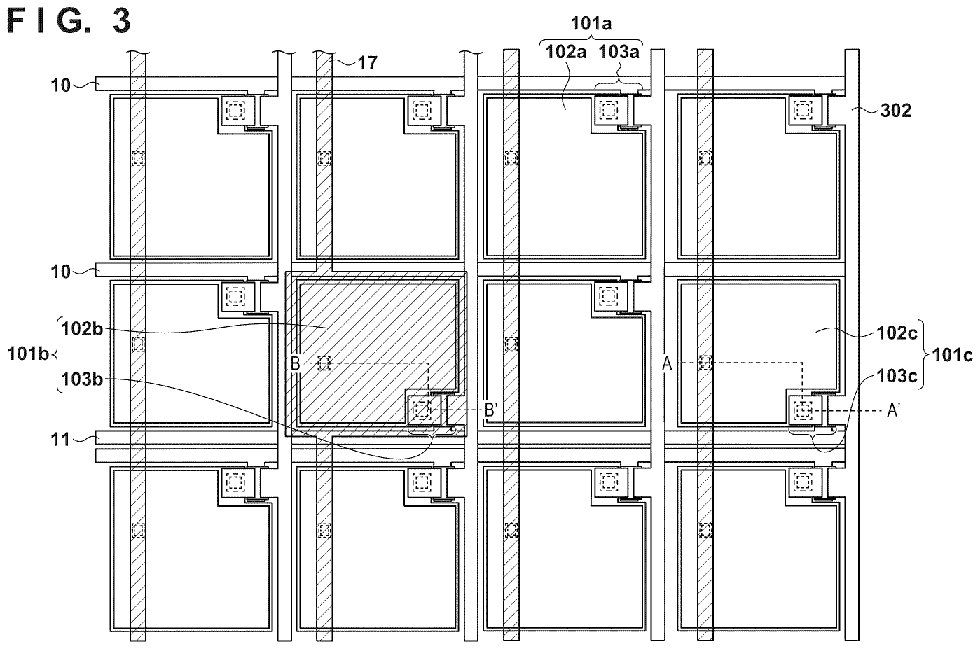

FIG. 3 is a plan view of the pixels 101 arranged in the image capturing region IR. FIG. 3 shows the 12 pixels 101. These pixels are the image capturing pixels 101a except for the one correction pixel 101b and the one detection pixel 101c. As described above, the pixel 101 is provided with the conversion element 102. The bias line 17 is provided above the conversion element 102, and the upper electrode of the conversion element 102 is connected to the bias line 17. An opening region which is a region capable of detecting radiation or light converted from radiation by the scintillator can be the region of the conversion element 102 that is not shielded by the bias line 17. As shown in FIG. 3, in order to improve the sensitivity of the image capturing pixel 101a and the detection pixel 101c with respect to radiation, the areas of the opening regions of the image capturing pixel 101a and the detection pixel 101c can be designed to be as large as possible. Electric charge corresponding to the radiation incident on this opening region is accumulated in the conversion element 102, and the accumulated electric charge is supplied to the signal line 302 via the switch element 103.

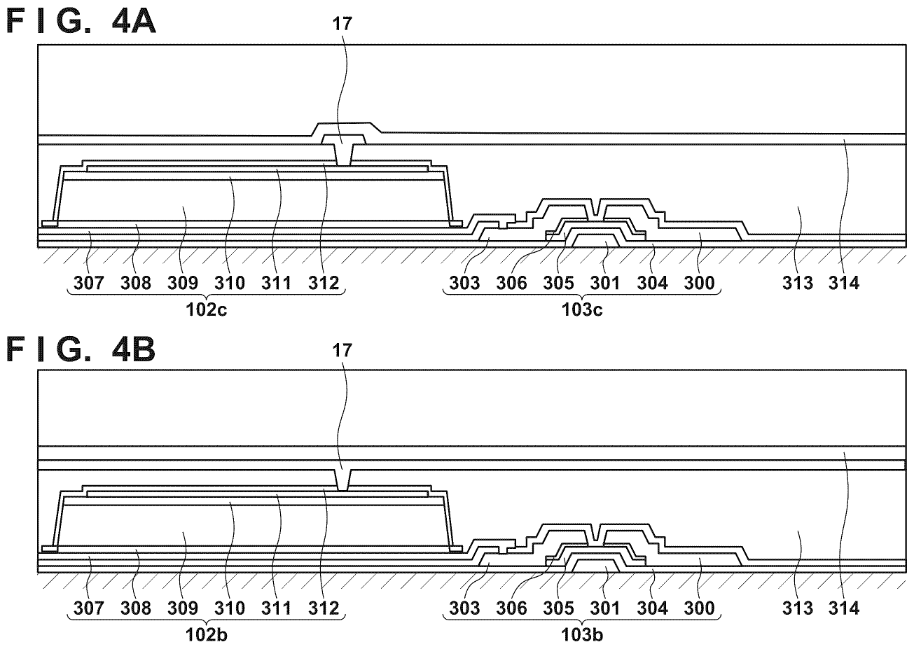

FIG. 4A is a sectional view of the detection pixel 101c taken along line A-A′ in FIG. 3. The conversion element 102c is depicted on the left side of FIG. 4A, and the switch element 103c is depicted on the right side. The switch element 103c can include a gate electrode 301, electrodes 300 and 303 respectively functioning as a source electrode and a drain electrode, an insulating layer 304, a semiconductor layer 305, and an impurity semiconductor layer 306. The conversion element 102c can include a lower electrode 307, an impurity semiconductor layer 308, a semiconductor layer 309, an impurity semiconductor layer 310, an upper electrode 311, and a protective layer 312. The electrode 303 is connected to the lower electrode 307. The upper electrode 311 is connected to the bias line 17 via a contact via. The gate electrode 301 of the switch element 103c constitutes part of the drive line 11, and the electrode 300 constitutes part of the signal line 302. When a drive signal is supplied to the drive line 11 to turn on the switch element 103c, the electric charge accumulated in the conversion element 102c is transferred as an electrical signal to the signal line 302. A light-shielding layer formed of a metal or the like may be provided on the switch element 103c. The light-shielding layer may be formed from, for example, the same metal layer as the bias line 17 and connected to a bias line. Shielding the switch element 103c will irradiate the semiconductor layer of the switch element 103c with light, thereby suppressing the generation of electric charge that is a cause of noise or the leakage of accumulated electric charge in the conversion element 102c. The drive line 10 is also connected to the image capturing pixel 101a. In addition, the image capturing pixel 101a can have the same arrangement as that of the detection pixel 101c. For this reason, a description of the sectional structure of the image capturing pixel 101a will be omitted.

FIG. 4B is a sectional view of the correction pixel 101b taken along line B-B′ in FIG. 3. The correction pixel 101b differs from the detection pixel 101c in that the conversion element 102b is covered with a light-shielding layer. Other configurations of the correction pixel 101b may be the same as those of the detection pixel 101c. The light-shielding layer is formed of the same metal layer as the bias line 17. Although not shown in FIGS. 4A and 4B, the scintillator is provided above the layer on which the bias line 17 is provided (on the side opposite to the conversion element 102). In addition, in using the conversion element 102 that directly converts radiation into an electrical signal, for example, tungsten or the like used for the bias line 17. This makes the correction pixel 101b have radiation sensitivity different from that of the image capturing pixel 101a and the correction pixel 101b. More specifically, the radiation sensitivity of the correction pixel 101b becomes much lower than that of the image capturing pixel 101a and the detection pixel 101c. For example, an output from the correction pixel 101b can be regarded as not corresponding to the radiation entering the correction pixel 101b.

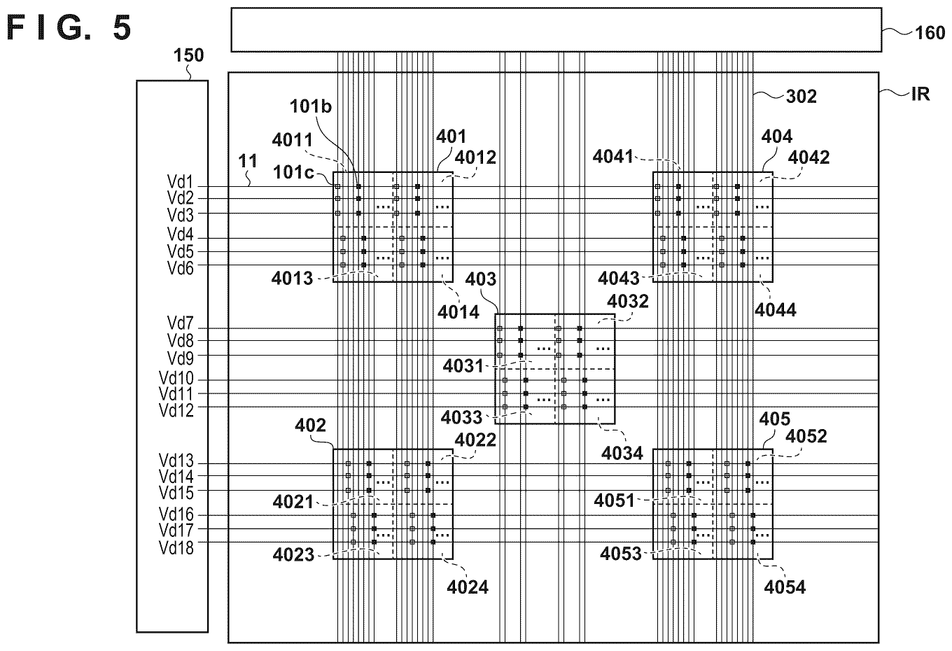

FIG. 5 is a view for explaining the receptor fields arranged in the image capturing region IR. A receptor field is a region that is set to acquire the irradiation information of radiation independently of a radiation image. The arrangement shown in FIG. 5 is an example in which five receptor fields 401 to 405 are arranged in the image capturing region IR. The receptor fields 401 to 405 are regions for detecting the doses of incident radiation as irradiation information during irradiation with radiation. The doses of radiation are detected by using the plurality of detection pixels 101c arranged in the receptor fields 401 to 405. Although the receptor fields 401 to 405 are arranged in the image capturing region IR, the receptor fields 401 to 405 can be arranged by various methods. For example, arranging the receptor fields symmetrically about the center of the image capturing region IR makes it possible to use the receptor fields 401 to 405 in the same manner regardless of the orientation of the radiation image capturing device 100 in use. The shape of each receptor field may be rectangular such as square or oblong, circular, or elliptical. In addition, the shape of each of the receptor fields 401 to 405 may be a shape conforming to the shape of an object. As shown in FIG. 5, the receptor fields 401 to 405 each can be constituted by predetermined numbers of pixels 101 continuous in the row direction and the column direction. In automatic exposure control (AEC), the doses of radiation applied to the receptor fields 401 to 405 are detected by reading out outputs from the plurality of detection pixels 101c arranged in the receptor fields 401 to 405 during irradiation with radiation. It is possible to arbitrarily set any of the receptor fields 401 to 405 as a receptor field to be used to detect the dose of incident radiation depending on conditions such as a region to be imaged.

As shown in FIG. 5, the receptor fields 401 to 405 each include a plurality of detection regions each including one or more detection pixel 101c of the plurality of detection pixels 101c. According to the arrangement shown in FIG. 5, the receptor fields 401 to 405 each are constituted by four detection regions. More specifically, the receptor field 401 is constituted by detection regions 4011 to 4014. The receptor field 402 is constituted by detection regions 4021 to 4024. The receptor field 403 is constituted by detection regions 4031 to 4034. The receptor field 404 is constituted by detection regions 4041 to 4044. The receptor field 405 is constituted by detection regions 4051 to 4054. The receptor fields 401 to 405 each can also be regarded as including detection regions each constituted by predetermined numbers of pixels 101, of the plurality of pixels 101, which are continuous in the row direction and the column direction. In addition, as shown in FIG. 5, the plurality of detection regions 4011 to 4054 constituting the respective receptor fields 401 to 405 each may include one or more correction pixels 101b of the plurality of correction pixels 101b. In this case, the number of detection regions arranged in one receptor field is not limited to four and may be two or three or five or more.

In each of the receptor fields 401 to 405, the plurality of detection pixels 101c are respectively connected to different signal lines of the plurality of signal lines 302 for each detection region of the plurality of detection regions 4011 to 4054. Likewise, in each of the receptor fields 401 to 405, the plurality of correction pixels 101b are respectively connected to different signal lines of the plurality of signal lines 302 for each detection region of the plurality of detection regions 4011 to 4054. This enables the signal processing circuit 170 to acquire irradiation information based on the signals supplied from the detection pixels 101c respectively arranged in a plurality of detection regions by causing the drive circuit 150 to drive the detection pixels, of the plurality of detection pixels 101c, which are arranged in the receptor field set to acquire irradiation information during irradiation with radiation. In addition, the drive circuit 150 can simultaneously drive the detection pixels 101c respectively arranged in a plurality of detection regions (for example, the detection regions 4011 to 4014) in each receptor field (for example, the receptor field 401) set to acquire irradiation information such as a radiation dose. Likewise, the drive circuit 150 can simultaneously drive the correction pixels 101b and the detection pixels 101c respectively arranged in a plurality of detection regions (for example, the detection regions 4011 to 4014) in each receptor field (for example, the receptor field 401) of the set receptor fields.

In each receptor field, the detection pixels 101c are connected to different signal lines of the plurality of signal lines 302 for each detection region. This makes it possible to separately acquire signals from the detection pixels 101c arranged in the respective detection regions. Assume that no target region is provided on the detection region 4011 of the detection regions 4011 to 4014 constituting the receptor field 401 to form a blank spot, whereas target regions overlap the remaining detection regions 4012 to 4014. In this case, the signal value output from the detection pixel 101c arranged in the detection region 4011 can be larger than the signal value output from each of the detection pixels 101c arranged in the remaining detection regions 4012 to 4014. In this case, the signal processing circuit 170 selects detection regions for the acquisition of irradiation information such as a radiation dose from the plurality of detection regions 4011 to 4014 based on the signals output from the detection pixels 101c respectively arranged in the plurality of detection regions 4011 to 4014. In the above case, the signal processing circuit 170 selects the detection regions 4012 to 4014 as detection regions for the acquisition of irradiation information. With this operation, the signal processing circuit 170 acquires irradiation information based on outputs from the detection pixels 101c arranged in the detection regions 4012 to 4014 selected from the plurality of detection regions 4011 to 4014. This improves the AEC detection accuracy in the radiation image capturing device 100. In addition, in each receptor field, signals are simultaneously read out from the detection pixels 101c (and the correction pixels 101b) arranged in all the detection regions. This makes it possible to speed up the detection of a radiation dose and further improve the AEC detection accuracy.

In the arrangement shown in FIG. 5, the detection pixels 101c and the correction pixels 101b in the four detection regions 4011 to 4054 in each of the five receptor fields 401 to 405 are all connected to the different signal lines 302. This arrangement makes it possible to simultaneously read out signals from the detection pixels 101c and the correction pixels 101b arranged in all the detection regions 4011 to 4054 in each of the receptor fields 401 to 405. This makes it possible to perform a dose detecting operation in AEC at high speed. Consequently, it is possible to reduce the exposure dose.

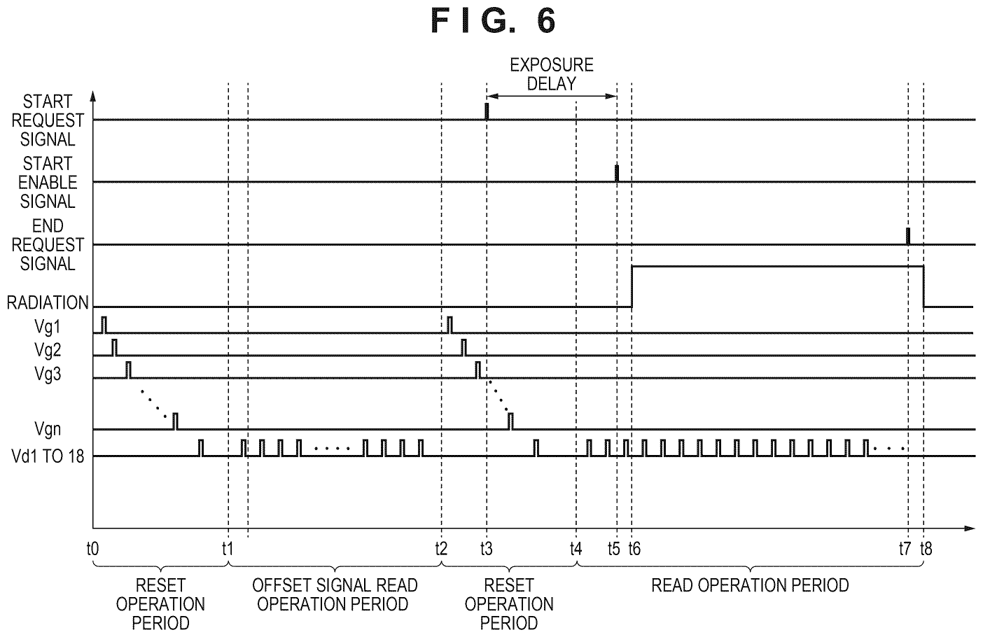

FIG. 6 shows an example of the operation of the radiation image capturing device 100 having the arrangement shown in FIG. 5. Reference symbols Vg1 to Vgn shown in FIG. 6 denote signals respectively supplied to the drive lines 10 corresponding to the first to nth pixel rows to drive the image capturing pixels 101a. In addition, as also shown in FIG. 5, reference symbols Vd1 to Vd18 denote signals respectively supplied to the drive lines 11 corresponding to the pixel rows on which the detection pixels 101c and the correction pixels 101b are arranged to drive the detection pixels 101c and the correction pixels 101b. For example, the signal Vd1 is a signal for driving the detection pixels 101c and the correction pixels 101b arranged on a given pixel row arranged in the detection regions 4011 and 4012 in the receptor field 401 and the detection regions 4041 and 4042 in the receptor field 404.

The radiation image capturing device 100 starts and repeats a reset operation from time to. The reset operation can be the operation of sweeping away the electric charge accumulated in the conversion elements 102 arranged in the respective pixels 101. From time t1, the radiation image capturing device 100 starts the same operation as a read operation performed during irradiation with radiation. This is an offset signal read operation for acquiring a correction value Od for an offset signal from the detection pixel 101c and a correction value Oc for an offset signal from the correction pixel 101b. In this case, the read operation is the operation of reading out signals originated from the electric charge accumulated in the detection pixel 101c and the correction pixel 101b by supplying a drive signal to the drive line 11. Acquiring offset correction values before the reception of a start request signal for irradiation with radiation can acquire correction values without influencing the exposure delay of radiation. Accordingly, it is possible to perform a read operation in an offset signal read operation many times (for example, several thousand times) and improve the correction accuracy by suppressing the influence of noise on offset correction values by averaging the read signals. Upon performing the offset signal read operation a predetermined number of times, the radiation image capturing device 100 repeats a reset operation again from time t2. Upon receiving a start request signal for irradiation with radiation at time t3, the radiation image capturing device 100 performs the reset operation of scanning all the drive lines 10 and 11 including the drive lines 11 connected to the detection pixels 101c and the correction pixels 101b and then starts a read operation from time t4. The radiation image capturing device 100 transmits a start enable signal at time t5 and starts irradiation with radiation from time to. Since the offset correction values have already been acquired as described above, the radiation image capturing device 100 can start irradiation with radiation immediately after receiving the start request signal. This makes it possible to shorten the exposure delay corresponding to the acquisition time of the offset correction values. Alternatively, the radiation image capturing device 100 may transmit a start enable signal to start irradiation with radiation after the lapse of a predetermined time (for example, several ms to several ten ms) since the shift from the reset operation to the read operation. This makes it possible to suppress readout of signals from the detection pixels 101c and the correction pixels 101b in a period immediately after the shift from the reset operation to the read operation in which the output variation is large. When irradiation with radiation is started, signal correction is performed by using the offset correction values Od and Oc with respect to the signal values output from the detection pixel 101c and the correction pixel 101b, thereby acquiring the dose of incident radiation. More specifically, the signal processing circuit 170 performs correction by calculating the difference between a signal value Sd of the signal output from the detection pixel 101c during irradiation with radiation and a signal value Sc of the signal output from the correction pixel 101b according to the following equation:

$$DOSE = ( Sd - Od ) - ( Sc - Oc )$$

This makes it possible to perform offset correction with respect to the signals output from the detection pixel 101c and the correction pixel 101b.

Exemplified here is a method of acquiring an offset correction value in a reset operation period before the reception of a start request signal. However, limitation is not made thereto. The acquisition timing of an offset correction value may be after the reception of a start request signal and before the transmission of an irradiation start enable signal. Acquiring an offset correction value immediately before irradiation with radiation in this manner makes it possible to suppress the influence of offset variation due to a change in the temperature of the radiation image capturing device 100 or the like. In addition, as in the present embodiment, correcting the signals read out from the detection pixels 101c by using the signals simultaneously read out from the correction pixels 101b can correct dark components included in the signals output from the detection pixels 101c.

In addition, since the detection pixels 101c and the correction pixels 101b arranged in the receptor fields 401 to 405 are connected to the different signal lines 302 for each of all the detection regions, the drive lines 11 (Vd1 to Vd18) can acquire the signals separately output from the detection pixels 101c and the correction pixels 101b for each of the detection regions 4011 to 4054 even when drive signals are supplied at the same timing. This makes it possible to speed up a dose detecting operation in AEC and hence eventually to suppress an exposure dose.

In the arrangement shown in FIG. 5, three each of the detection pixels 101c and the correction pixels 101b are connected to the one signal line 302. However, two or less pixels or four or more pixels may be connected. As the numbers of the detection pixels 101c and the correction pixels 101b increase, an increase in SNR and an improvement in offset correction accuracy can be expected. On the other hand, as the numbers of the detection pixels 101c and the correction pixels 101b increase excessively, the number of pixels that become deficits due to the absence of the image capturing pixels 101a increases, resulting in difficulty in correction using image processing. For this reason, the placement positions and the numbers of the detection pixels 101c and the correction pixels 101b may be properly determined in consideration of the tradeoff relationship between them.

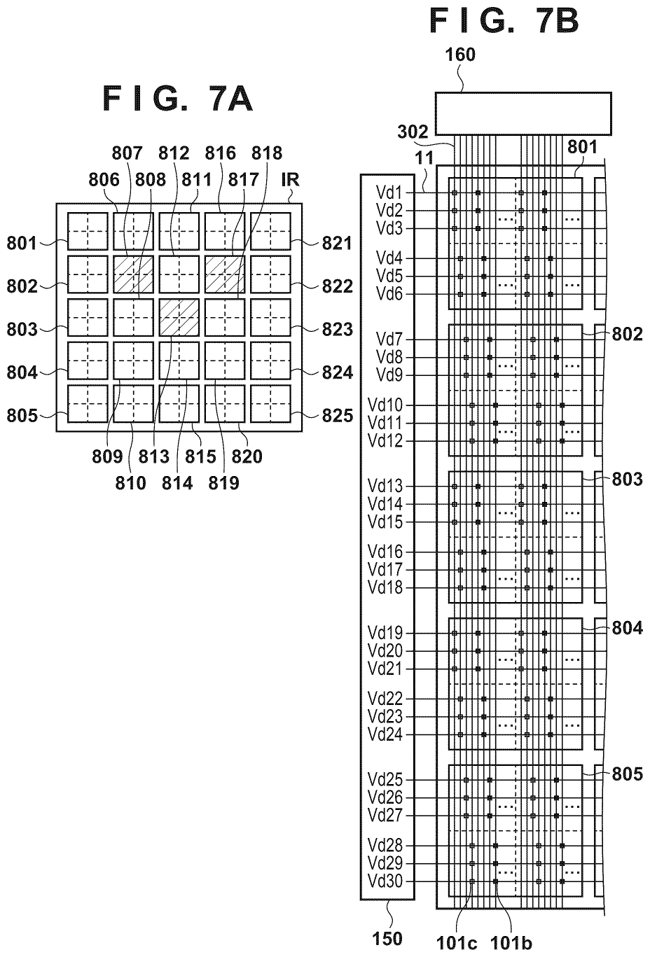

The placement of receptor fields different from that in the above embodiment will be described next with reference to FIGS. 7A and 7B. FIG. 7A is a view showing the placement of receptor fields 801 to 825 in the present embodiment. FIG. 7B is a view focusing on the receptor fields 801 to 805, of the 25 receptor fields 801 to 825 shown in FIG. 7A, which are arranged side by side on one column on the left side in the column direction.

As shown in FIG. 7A, the number of receptor fields present in the image capturing region IR increases to 5×5=25 regions as compared with the above embodiment. In addition, as shown in FIG. 7B, this arrangement includes both a case where the detection pixels 101c and the correction pixels 101b arranged in different receptor fields are connected to the same signal line 302 and a case where the detection pixels 101c and the correction pixels 101b are connected to the different signal lines 302. On the other hand, as in the above embodiment, the receptor fields 801 to 825 are divided into four detection regions as indicated by the broken lines, and the detection pixels 101c and the correction pixels 101b respectively arranged in the four detection regions in each of the receptor fields 801 to 825 are connected to the different signal lines 302 for each detection region.

As shown in FIG. 7B, the detection pixels 101c arranged in the receptor field 801, the detection pixels 101c arranged in the receptor field 803, and the detection pixels 101c arranged in the receptor field 804 are connected to the same signal line 302 of the plurality of signal lines 302. In addition, the detection pixels 101c arranged in the receptor field 802 and the detection pixels 101c arranged in the receptor field 805 are connected to the same signal line 302 of the plurality of signal lines 302. Likewise, the correction pixels 101b arranged in the receptor field 801, the correction pixels 101b arranged in the receptor field 803, and the correction pixels 101b arranged in the receptor field 804 are connected to the same signal line 302 of the plurality of signal lines 302. In addition, the correction pixels 101b arranged in the receptor field 802 and the correction pixels 101b arranged in the receptor field 805 are connected to the same signal line 302 of the plurality of signal lines 302. On the other hand, the detection pixels 101c arranged in the receptor fields 801, 803, and 804 and the detection pixels 101c arranged in the receptor fields 802 and 805 are connected to the different signal lines 302. Likewise, the correction pixels 101b arranged in the receptor fields 801, 803, and 804 and the correction pixels 101b arranged in the receptor fields 802 and 805 are connected to the different signal lines 302.

Assume that in this case, the signals output from the detection pixels 101c and the correction pixels 101b are individually acquired for each detection region. In this case, it is necessary to drive the detection pixels 101c and the correction pixels 101b arranged in the receptor field 801, the detection pixels 101c and the correction pixels 101b arranged in the receptor field 803, and the detection pixels 101c and the correction pixels 101b arranged in the receptor field 804 at different timings. Likewise, it is necessary to drive the detection pixels 101c and the correction pixels 101b arranged in the receptor field 802 and the detection pixels 101c and the correction pixels 101b arranged in the receptor field 805 at different timings. On the other hand, it is necessary to drive the detection pixels 101c and the correction pixels 101b arranged in the receptor fields 801, 803, and 804 and the detection pixels 101c and the correction pixels 101b arranged in the receptor fields 802 and 805 at the same timing.

Although FIG. 7B is a view focusing on the receptor fields 801 to 805 arranged side by side on one column on the left side in the column direction shown in FIG. 7A, the detection pixels 101c and the correction pixels 101b may be arranged on the remaining four columns at the identical positions (pixel rows) as those in the receptor fields 801 to 805. This makes it possible to drive all the detection pixels 101c and the correction pixels 101b arranged in the image capturing region IR by using the 30 drive lines 11 to which the signals Vd1 to Vd30 are supplied.

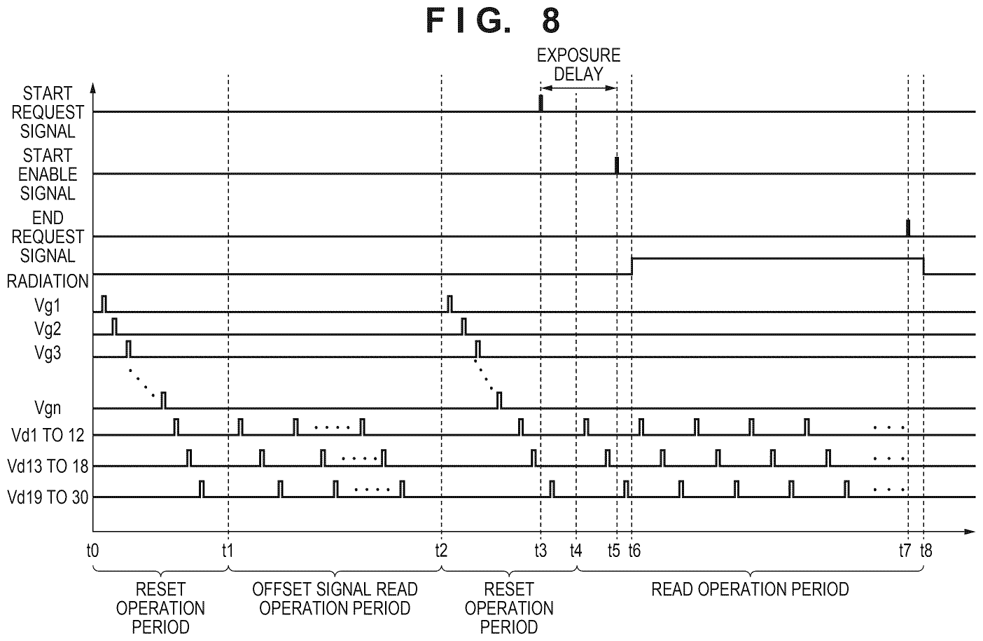

Described next with reference to FIG. 8 is an operation example in which all the receptor fields of the 25 receptor fields 801 to 825 shown in FIG. 7A are selected to acquire irradiation information such as the dose of incident radiation. This operation example differs from the operation example shown in FIG. 6 in that in order to separately acquire signals from the detection pixels 101c and the correction pixels 101b arranged in different detection regions but connected to the same signal line 302, the timings at which drive signals are supplied to the drive lines 11 are made different. As shown in FIG. 8, drive signals are supplied separately to the drive line 11 group to which the signals Vd1 to Vd12 are supplied, the drive line 11 group to which the signals Vd13 to Vd18 are supplied, and the drive line 11 group to which the signals Vd19 to Vd30 are supplied. This makes it possible to drive the detection pixels 101c and the correction pixels 101b connected to the same signal line 302 at different timings and separately acquire signals. That is, in each of the receptor fields 801 to 825, signals can be acquired from the detection pixels 101c and the correction pixels 101b for each detection region. Signals can be read out from the detection pixels 101c and the correction pixels 101b connected to the different signal lines 302 at the same timing. As in the present embodiment, as the set number of receptor fields in the image capturing region IR which are used for AEC increases, it becomes more difficult to respectively connect the different signal lines 302 to the detection pixels 101c and the correction pixels 101b arranged in all the detection regions. Accordingly, the detection pixels 101c and the correction pixels 101b are connected to the different signal lines 302 for each detection region within a possible range. Even when the detection pixels 101c and the correction pixels 101b in different detection regions are connected to the same signal line 302, different drive timings are set. This makes it possible to separately read out signals from the detection pixels 101c and the correction pixels 101b for each detection region in each of the receptor fields 801 to 825.

In the arrangement example shown in FIGS. 5 and 7B, the drive circuit 150 includes a plurality of output terminals respectively corresponding to the plurality of drive lines 10 and 11. The drive lines 10 and 11 can be regarded as being wired to enable the drive circuit 150 to separately supply drive signals to all the drive lines 10 and 11. For example, it is conceivable to bundle the drive lines 11 to be simultaneously driven into one wiring pattern before the drive circuit 150. In this case, the wiring capacity of the drive line 11 becomes excessive, so that it may result in delaying the pulses of drive signals at the time of supplying drive signals. For this reason, the radiation image capturing device 100 according to the present embodiment is wired to be able to separately supply drive signal from the drive circuit 150 to the respective drive lines 10 and 11.

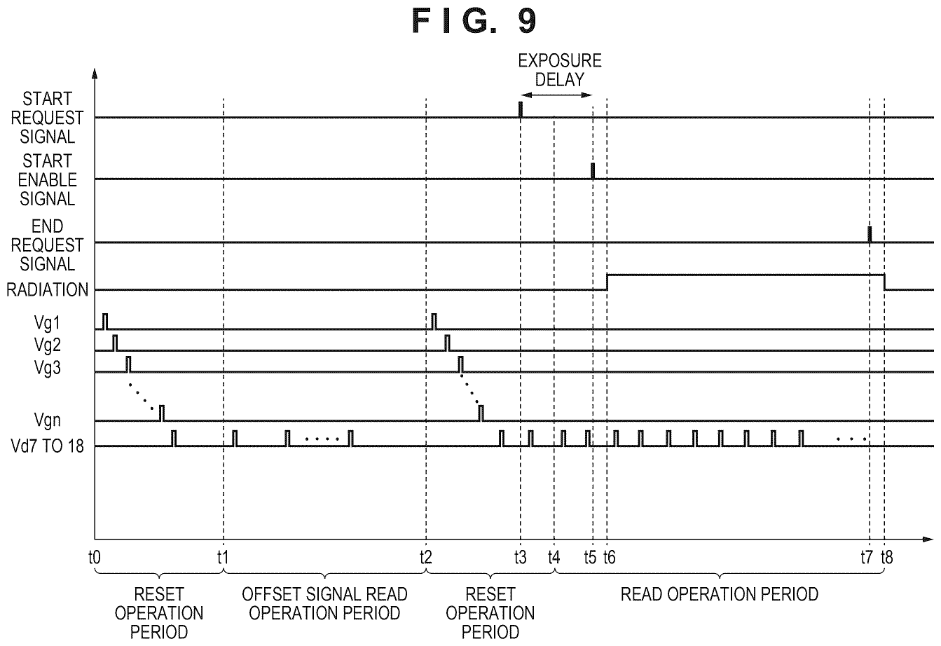

The operation example shown in FIG. 8 indicates drive timings when the 25 receptor fields 801 to 825 shown in FIG. 7A are all selected for the acquisition of irradiation information. FIG. 9 shows an operation example in a case where the three receptor fields 807, 813, and 817 of the 25 receptor fields 801 to 825 shown in FIG. 7A are selected for the acquisition of irradiation information. Referring to FIG. 8, the detection pixels 101c and the correction pixels 101b are driven upon dividing the drive lines 11 into three groups, namely a drive line 11 group to which the signals Vd1 to Vd12 are supplied, a drive line 11 group to which the signals Vd13 to Vd18 are supplied, and a drive line 11 group to which the signals Vd19 to Vd30 are supplied. On the other hand, in the operation example shown in FIG. 9, the drive line 11 group to which the signals Vd7 to Vd18 are supplied is collectively driven. In the drive line 11 group to which the signals Vd7 to Vd18 are supplied, four detection regions are arranged in the column direction, and the detection pixels 101c and the correction pixels 101b are connected to the different signal lines 302 for each detection region. Accordingly, even when the drive line 11 group to which the signals Vd7 to Vd18 are supplied is collectively driven, it is possible to separately acquire signals from the detection pixels 101c and the correction pixels 101b for each detection region in each of the receptor fields 807, 813, and 817. In addition, in the operation example shown in FIG. 8, drive signals are supplied, at different timings, to the drive line 11 group to which the signals Vd7 to Vd12 are supplied and the drive line 11 group to which the signals Vd13 to Vd18 are supplied. In the operation example shown in FIG. 9, drive signals are supplied, at the same timing, to the drive line 11 group to which the signals Vd7 to Vd12 are supplied and the drive line 11 group to which the signals Vd13 to Vd18 are supplied. This is because, in each receptor field, the first object is to acquire signals from the detection pixels 101c and the correction pixels 101b for each detection region. In addition, ideally, irradiation information of the detection regions in a selected receptor field are simultaneously acquired, and the readout intervals are shortened, thereby improving the AEC temporal resolution. Accordingly, when the signal lines 302 connected to the detection pixels 101c and the correction pixels 101b arranged in the receptor fields selected for the acquisition of irradiation information differ for each receptor field, drive signals are supplied to all the drive lines 11 as signal readout targets at the same timing. In contrast to this, when the detection pixels 101c and the correction pixels 101b arranged in selected receptor fields are connected to the same signal line 302, drive signals are supplied to the drive lines 11 at different timings so as to separately acquire signals from the detection pixels 101c and the correction pixels 101b. In this manner, the radiation image capturing device 100 may switch drive control in read operations in accordance with the receptor fields selected to acquire irradiation information such as an incident dose of radiation.

For example, AEC or the like is often performed by using a receptor field arranged in the middle of the image capturing region IR. Accordingly, for example, in the arrangement shown in FIG. 7B, the detection pixels 101c and the correction pixels 101b arranged in the receptor field 803 and the detection pixels 101c and the correction pixels 101b arranged in the receptor field 804 may be connected to the different signal lines 302. It is possible to acquire signals, at the same timing, from the detection pixels 101c and the correction pixels 101b arranged in the receptor fields (the receptor fields 807 and 817) arranged side by side with the receptor field 802 in the row direction and in the receptor field (the receptor field 813) arranged side by side with the receptor field 803 in the row direction. In addition, it is possible to acquire signals, at the same timing, from the detection pixels 101c and the correction pixels 101b arranged in the receptor field arranged side by side with the receptor field 803 in the row direction and in the receptor field arranged side by side with the receptor field 804 in the row direction.

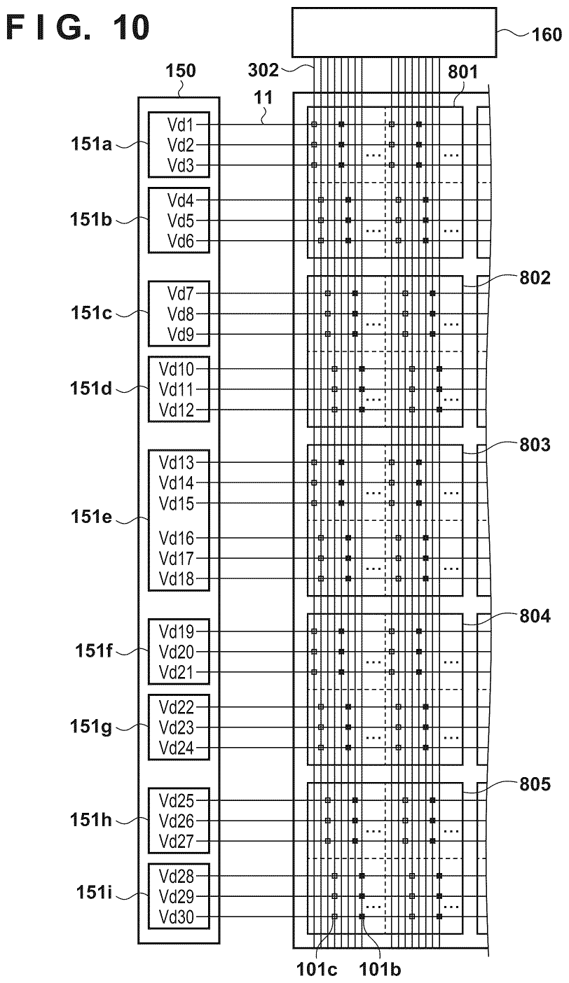

Furthermore, as shown in FIG. 10, the drive circuit 150 may be configured so as to include a plurality of drive chips 151a to 151i. Each of the drive chips 151a to 151i can separately include, for example, a shift register or the like for sequentially outputting drive signals to the drive lines 10 and 11. In other words, a shift register for sequentially outputting drive signals to the drive lines 10 and 11 is not arranged across each of the drive chips 151a to 151i. In this case, the drive chips 151a to 151i each are connected so as to drive the detection pixels 101c and the correction pixels 101b arranged in one receptor field of the plurality of receptor fields 801 to 805 arranged side by side in the column direction. In other words, the detection pixels 101c, of the plurality of detection pixels 101c (the correction pixels 101b), which are arranged in each of the receptor fields 801 to 805 arranged side by side in the column direction are driven by different drive chips of the plurality of drive chips 151a to 151i for each receptor field. In this manner, the drive chips 151a to 151i are connected to the drive lines 11 so as not to straddle two or move receptor fields of the receptor fields 801 to 805 arranged side by side in the column direction. If one drive chip 151 (the drive circuit 150) tries to individually control the detection pixels 101c and the correction pixels 101b arranged in two or more receptor fields arranged side by side in the column direction, there is a possibility of complicating drive control. Depending on the specifications of the drive chip 151 (the drive circuit 150), there is a possibility of not being able to cope with an operation example like that described above (for example, the operation example shown in FIG. 8). For this reason, the drive chips 151a to 151i constituting the drive circuit 150 may be respectively connected to the drive lines 10 and 11 so as not to straddle the receptor fields 801 to 805 arranged side by side in the column direction. Although there is no description about the connection of the plurality of drive chips 151a to 151i to the drive lines 10, they may be connected to each other as needed. In addition, the drive chip 151 other than the plurality of drive chips 151a to 151i may be provided for the drive circuit 150 and connected to the corresponding drive line 10.

In addition, as described above, receptor fields near the middle of the image capturing region IR are frequently used for AEC or the like. For this reason, for example, in some case, irradiation information is acquired by using only the receptor fields 808, 813, 818, and 823 arranged side by side with the receptor field 803 in the row direction. In such a case as well, connecting the one drive chip 151 to the drive line 11 so as not to straddle two or more receptor fields makes it possible to simplify the drive control of the drive chip 151. In addition, one drive chip 151 may be assigned to one receptor field as in the case of the drive chip 151e, or two or move drive chips 151 may be assigned to one receptor field as in the case of the remaining drive chips 151 shown in FIG. 10.

According to the present disclosure, it is possible to provide a technique advantageous in improving the AEC accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157732, filed Sep. 11, 2024, which is hereby incorporated by reference herein in its entirety.

What is claimed is:

1. A radiation image capturing device comprising:
an image capturing region in which a plurality of pixels are arranged in a matrix pattern;
a plurality of signal lines to which signals are respectively supplied from pixels, of the plurality pixels, which are arranged on a same pixel column;
a signal processing circuit; and
a drive circuit,
wherein the plurality of pixels include a plurality of image capturing pixels for acquiring a radiation image and a plurality of detection pixels for acquiring irradiation information of radiation separately from the radiation image,
the image capturing region includes a plurality of receptor fields each constituted by a predetermined number of pixels, of the plurality of pixels, which are continuous in a row direction and a column direction,
each receptor field includes a plurality of detection regions each including not less than one detection pixel of the plurality of detection pixels, the plurality of detection regions being connected to different signal lines of the plurality of signal lines for each of the plurality of detection regions in each receptor field, and
the signal processing circuit acquires the irradiation information based on signals supplied from detection pixels arranged in each of the plurality of detection regions by causing the drive circuit to drive detection pixels, of the plurality of detection pixels, which are arranged in a receptor field set for acquisition of the irradiation information during irradiation with radiation.

2. The device according to claim 1, wherein the signal processing circuit selects a detection region for acquisition of the irradiation information from the plurality of detection regions based on signals output from detection pixels arranged in each of the plurality of detection regions for each of the set receptor fields during irradiation with radiation, and acquires the irradiation information based on outputs from detection pixels arranged in a detection region selected from the plurality of detection regions.

3. The device according to claim 1, wherein the drive circuit simultaneously drives detection pixels arranged in each of the plurality of detection regions in each of the set receptor fields.

4. The device according to claim 1, wherein the plurality of pixels further include a plurality of correction pixels having radiation sensitivity different from radiation sensitivity of the plurality of detection pixels,
each of the plurality of detection regions includes not less than one correction pixel of the plurality of correction pixels, and
the plurality of correction pixels are connected to different signal lines of the plurality of signal lines for each of the plurality of detection regions.

5. The device according to claim 4, wherein the drive circuit drives the plurality of pixels via a plurality of drive lines, and
the plurality of detection pixels and the plurality of correction pixels include a detection pixel and a correction pixel connected to a same drive line of the plurality of drive lines.

6. The device according to claim 1, wherein the drive circuit drives the plurality of pixels via a plurality of drive lines, and
the plurality of image capturing pixels and the plurality of detection pixels are connected to different drive lines of the plurality of drive lines.

7. The device according to claim 6, wherein the drive circuit includes a plurality of output terminals respectively corresponding to the plurality of drive lines.

8. The device according to claim 1, wherein the plurality of receptor fields include a first receptor field and a second receptor field arranged side by side in a column direction,
a detection pixel of the plurality of detection pixels which is arranged in the first receptor field and a detection pixel of the plurality of detection pixels which is arranged in the second receptor field are connected to a same signal line of the plurality of signal lines, and
the drive circuit drives a detection pixel arranged in the first receptor field and a detection pixel arranged in the second receptor field at different timings during irradiation with radiation.

9. The device according to claim 8, wherein the plurality of receptor fields further include a third receptor field arranged side by side with the first receptor field in a column direction,
a detection pixel of the plurality of detection pixels which is arranged in the first receptor field and a detection pixel of the plurality of detection pixels which is arranged in the third receptor field are connected to different signal lines of the plurality of signal lines, and
the drive circuit drives a detection pixel arranged in the first receptor field and a detection pixel arranged in the third receptor field at same timing during irradiation with radiation.

10. The device according to claim 1, wherein the plurality of receptor fields include a first receptor field and a second receptor field arranged side by side in a column direction,
a detection pixel of the plurality of detection pixels which is arranged in the first receptor field and a detection pixel of the plurality of detection pixels which is arranged in the second receptor field are connected to different signal lines of the plurality of signal lines, and
the drive circuit drives a detection pixel arranged in the first receptor field and a detection pixel arranged in the second receptor field at same timing during irradiation with radiation.

11. The device according to claim 1, wherein the drive circuit is constituted by a plurality of drive chips,
the plurality of receptor fields include not less than two receptor fields arranged side by side in a column direction, and
detection pixels of the plurality of detection pixels which are respectively arranged in not less than the two receptor fields are driven by different drive chips of the plurality of drive chips for each of not less than the two receptor fields.

12. A radiation image capturing system comprising:
the radiation image capturing device according to claim 1; and
a signal processing unit configured to process a signal output from the radiation image capturing device.
